(19) United States
(12) Patent Application Publication
(10) Pub. No.: US 2001/0001563 A1
(43) Pub. Date: May 24, 2001

(54) METHOD AND APPARATUS TO CONTROL THE BEHAVIOR OF A DIGITAL CAMERA BY DETECTING CONNECTIVITY TO A UNIVERSAL SERIAL BUS

(76) Inventor: EDWARD P. TOMASZEWSKI, PHOENIX, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025

(21) Appl. No.: 09/080,764

(22) Filed: May 18, 1998

(51) Int. Cl. H04N 5/232

(52) U.S. Cl. 348/552; 348/207; 348/231

(57) ABSTRACT

A method for controlling behavior of a digital camera is disclosed. The method detects connectivity to a universal serial bus (USB) and automatically switches to a corresponding mode of operation depending on the result of the detecting.

### BACKGROUND OF THE INVENTION

(1) Field of the Invention

The present invention is in the field of digital cameras, more specifically, the method and apparatus of the present invention is related to controlling the behavior of a digital camera by detecting connectivity of the digital camera to a universal serial bus (USB) cable.

(2) Related Art

A digital camera like a traditional camera is capable of capturing images. Unlike a traditional camera, the digital camera focuses the images not onto light sensitive silver halide film but onto an image sensor made of a semiconductor material. One suitable image sensor of this type is known as a charge coupled device (CCD). The captured image data may then be converted to digital form by an analog-to-digital converter (ADC), compressed and stored in memory chips.

Currently available digital cameras are either configured as a tethered digital camera or a portable digital camera. More specifically, tethered digital cameras are configured to be coupled to a computer system to capture images for processing by the computer system and do not function in a stand alone environment. Portable digital cameras are similar to the traditional cameras configured for hand-carry use. Unfortunately, it is expensive and space consuming for a user to have both a tethered digital camera as well as a portable digital camera.

It is therefore desirable to have a method and apparatus that provides a dual-modality digital camera having the functionality of both a tethered digital camera as well as a portable digital camera and is capable of automatically switching between the two functionalities without user intervention.

### BRIEF SUMMARY OF THE INVENTION

A method for controlling behavior of a digital camera is disclosed. The method detects connectivity to a universal serial bus (USB) and automatically switches to a corresponding mode of operation depending on the result of the detecting.

### BRIEF DESCRIPTION OF THE DRAWINGS

FIG. 1 is an exemplary computer system block diagram with an implementation of the present invention.

FIG. 2 is an exemplary illustration of the universal serial bus (USB) cable illustrated in FIG. 1.

FIG. 3a illustrates a frontal view of an exemplary digital camera of the present invention.

FIG. 3b illustrates an exemplary rear view of the digital camera of the present invention.

FIG. 4 is an exemplary block diagram of the functional units of the present invention.

FIG. 5 illustrates an exemplary block diagram of the dual mode control mechanism of the present invention.

FIG. 6 illustrates an exemplary state machine of the present invention.

FIG. 7 is a flow diagram illustrating the general steps followed by the present invention.

### DETAILED DESCRIPTION OF THE INVENTION

The present invention supports dual mode operation in a digital camera for both portable and tethered mode functionality by automatically switching between the two functionalities without user intervention.

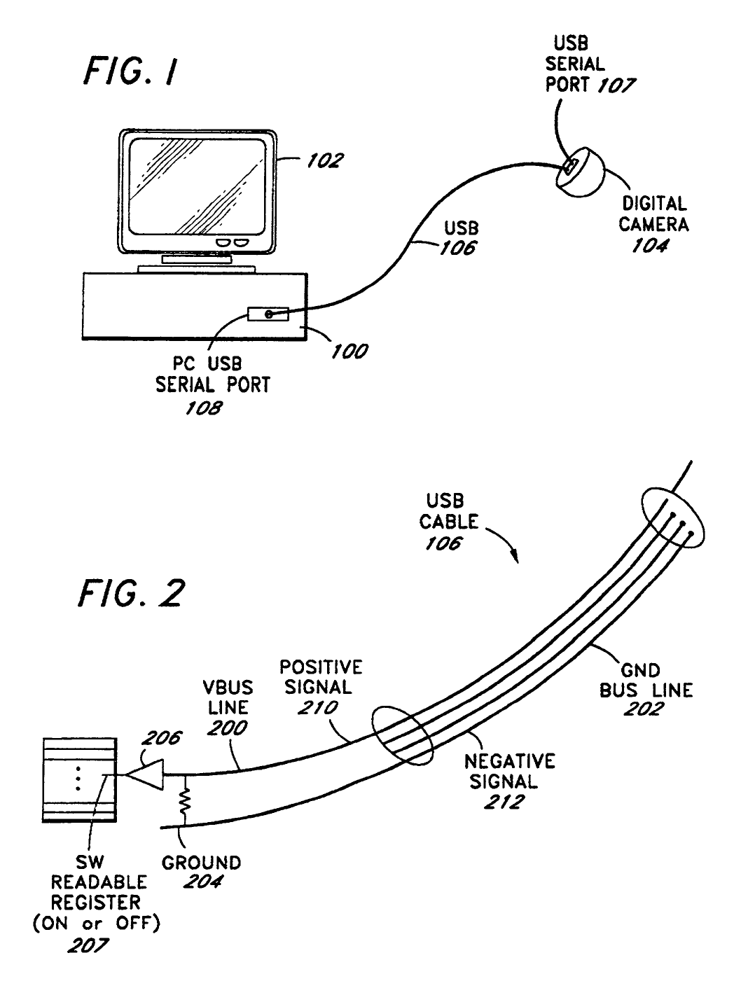

FIG. 1 is an exemplary host computer system block diagram with an implementation of the present invention. Computer system 100 is coupled to a display device, such as a monitor 102 and to the present invention's digital camera 104. The digital camera 104 is coupled to the host computer system 100 through a universal serial bus (USB) port 107 by a USB cable 106. The USB cable 106 is coupled to the host computer system 100 via a USB serial port 108. It may be appreciated by a person skilled in the art that although not shown, the host computer system 100 may be implemented with various other components typically found in a computer system.

The digital camera 104 of the present invention is configured to support dual mode operation for both portable and tethered mode functionality by automatically switching between the two functionalities without user intervention. The tethered mode referred to herein is the mode in which the digital camera 104 is physically coupled to the host computer system 100 through, for example, a USB cable 106 via the USB serial port 108. The portable mode referred to herein is the mode in which the digital camera 104 is functional when physically detached from the host computer system 100.

Although the host computer system 100 is illustrated in FIG. 1 as being coupled to only one digital camera, a person skilled in the art may appreciate from the detailed description provided herein that the present invention is capable of providing dual functionality to additional digital cameras couplable to the host computer system 100.

FIG. 2 is an exemplary USB cable 106 illustrated in FIG. 1. The USB cable 106 has a voltage bus (VBUS) line 200 and a ground (GND) bus line 202. The VBUS line 200 is one of the four wires of a USB cable 106 and provides active current to the device attached to the USB cable 106. The GND bus line 202 is a conductor having low impedance or high current carrying capacity, and feeds power to the digital camera 104. The VBUS line 200 carries a positive VBUS signal 210, and the GND bus line 202 carries a negative signal 212. Further, the GND bus line 202 is coupled to ground 204. The configuration of a typical USB cable with the four wires is well known in the art and needs no further discussion.

In the present invention, the VBUS line 200 is coupled to a software readable register 207 which stores data indicative of whether the VBUS line 200 is carrying current (also referred herein as a VBUS signal 210). When the presence of a VBUS signal 210 on the USB serial port 107 is detected, the digital camera 104 operates in tethered mode. In tethered mode, all processing is initiated by commands which are sent through the host computer system 100's USB serial port 108 to the digital camera 104's USB serial port 107. In one embodiment, the digital camera 104 has a limited command set which supports the digital camera activities, including capturing of still images and adjusting of parameters which control image exposure.

If a VBUS signal 210 is not detected, the digital camera 104 operates in portable mode. In portable mode, the digital camera 104 responds to depressions of various buttons which are accessible on the external body of the digital camera 104 as is typical for a traditional hand carried digital camera. Any information captured is recorded in a non-volatile memory (not shown) within the digital camera 104.

The present invention's use of the VBUS signal 210 to control the digital camera 104's behavior removes the need for having an extra user selectable switch to select between two modes. The convenience feature works in a fashion which is consistent with the user expectations of the required digital camera behavior, i.e., that tethered operations should automatically occur when the digital camera 104 is tethered.

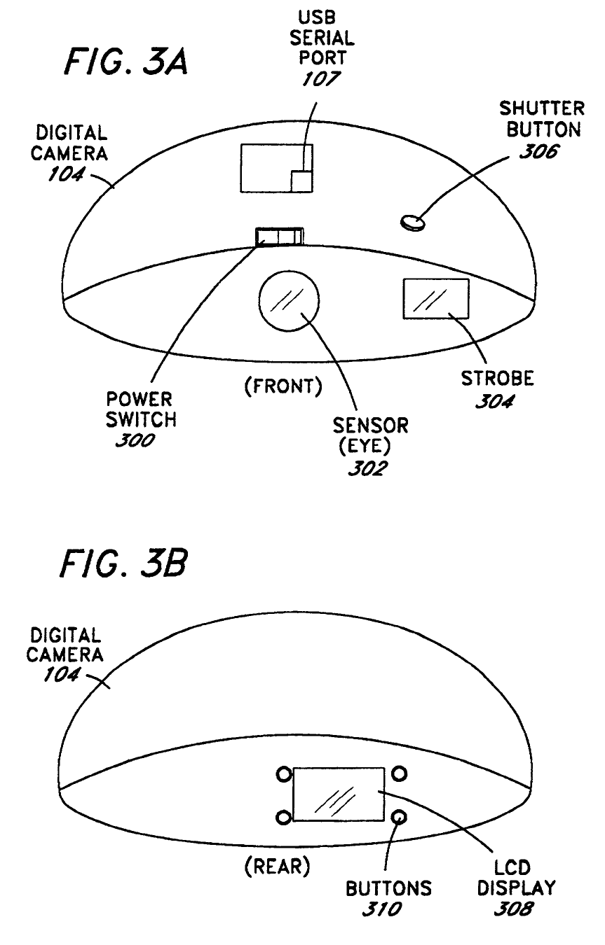

FIG. 3a illustrates a frontal view of an exemplary digital camera of the present invention. A digital camera 104 of the present invention has a USB serial port 107 to which the USB cable 106 is attached. The configuration of a USB serial port and a USB cable line and their attachments are well known in the art and need no further discussion.

Digital camera 104 may also have a power switch 300 which when depressed activates the digital camera 104, a sensor 302 which is configured to capture images, a strobe 304 (a flash bulb), and a shutter button 306 which initiates the capture of images when depressed.

FIG. 3b illustrates an exemplary rear view of the digital camera of the present invention. The digital camera 104 of the present invention may also have a liquid crystal display (LCD) 308 which displays, for example, the number of images captured by the video camera 104, and other status information. The digital camera 104 of the present invention may also have buttons 310 configured to activate various functions, including but not limited to changing the resolution of a captured image and enabling the strobe 304.

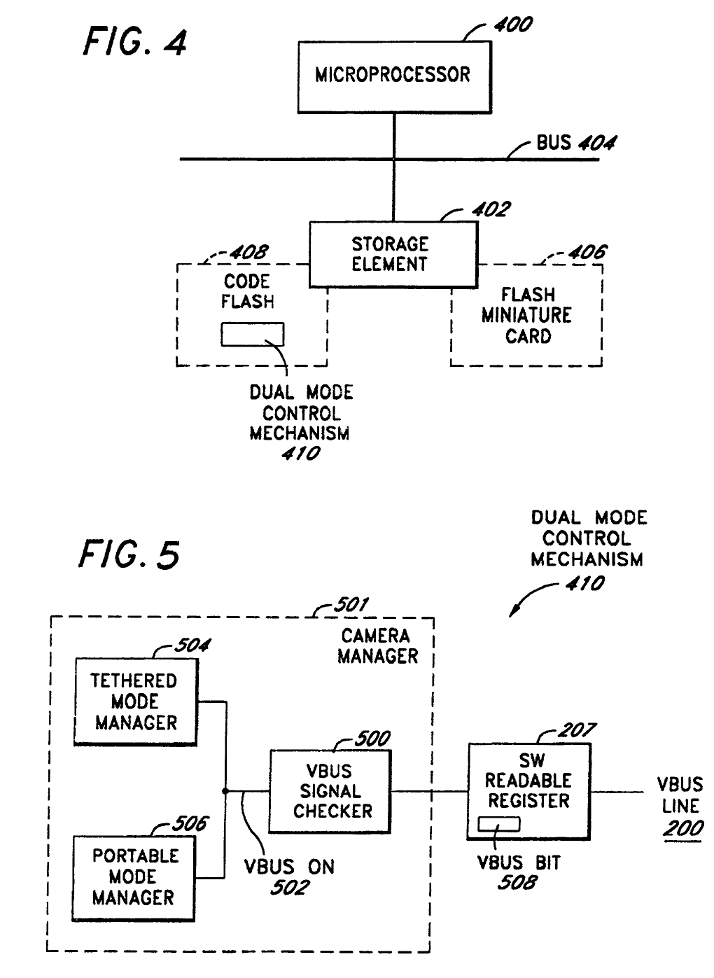

FIG. 4 is an exemplary block diagram of the functional units of the present invention. The digital camera 104 of the present invention has a microprocessor 400 which facilitates the execution of the firmware which controls the digital camera 104.

The digital camera 104 also has a storage element 402. The storage element 402 may include, but is not limited to, a flash miniature card memory 406 for recording images captured by the digital camera 104 and a code flash memory 408 for storing software that controls the functionality of the digital camera 104. The storage element 402 is coupled to the microprocessor 400 via a bus or buses 404. The code flash memory 408 has a dual mode control mechanism 410 of the present invention which supports dual mode operation for portable and tethered mode functionality. A person skilled in the art may appreciate that although not shown, a digital camera 104 may have other components typically found in a digital camera.

FIG. 5 illustrates an exemplary block diagram of the dual mode control mechanism 410 of the present invention. The dual mode control mechanism 410 of the present invention has a camera manager 501. The camera manager 501 has a VBUS signal checker 500, tethered mode manager 504 and a portable manager 506.

The present invention's camera manager 501 is implemented as a part of the firmware which controls the digital camera 104's behavior and supports live automatic transition between the tethered and the portable behavior and vice versa. The VBUS signal checker 500 of the camera manager 501 periodically polls for USB connectivity to allow the camera manager 501 to dynamically adjust the digital camera 104's behavior in real-time. The USB connectivity is detected by the presence of the VBUS signal 210 on the USB port 107. The VBUS line 200 of the USB cable 106 carries a positive voltage supply, also referred herein as the VBUS signal 210, to the digital camera 104 when connected.

In one embodiment, the VBUS signal 210 on VBUS line 200 causes a VBUS bit 508 in a software readable register 207 to be asserted. More specifically, the software readable register 207 asserts a status bit referred herein as a VBUS bit 508 indicative of an asserted VBUS signal 210. A VBUS checker 500 periodically polls the VBUS bit 508 and initiates the tethered mode when the VBUS bit 508 is asserted indicating that the VBUS signal 210 is on.

The asserted VBUS bit 508 notifies the camera manager 501 that the digital camera 104 is connected to the host computer system 100 through the USB cable 106. The camera manager 501 then enables a VBUS on message 502 indicating that the VBUS signal 210 is on and forwards the VBUS on message 502 to the tethered mode manager 504 and the portable mode manager 506.

If the VBUS signal 210 is on as indicated by the VBUS on message 502, the tethered mode manager 504 is activated. The tethered mode manager 504 polls the USB serial port 107 for incoming commands issued by the host computer system 100 and the digital camera 104 performs functions in the tethered mode according to the commands. Otherwise, if the VBUS signal 210 is off, then the portable mode manager 506 is activated and processes functions on the digital camera 104 in the portable mode.

More specifically, if a VBUS signal 210 is detected by the VBUS signal checker 500, then the digital camera 104 is in tethered mode. All processing is initiated by commands which are sent by the host computer system 100 through the USB port 107 to the digital camera 104. In one embodiment, the digital camera 104 has a limited command set which supports the activities required to capture still and video images and to adjust parameters which control the exposure. Any information captured is recorded in a non-volatile memory such as a flash miniature card 406 within the digital camera 104.

Otherwise, if a VBUS signal 210 is not detected by the VBUS signal checker 500, then the digital camera 104 is in portable mode. In a hand carry portable mode, the digital camera 104 operates by responding to depressions of various buttons that are accessible on the external body of the digital camera 104 as is well known in the art.

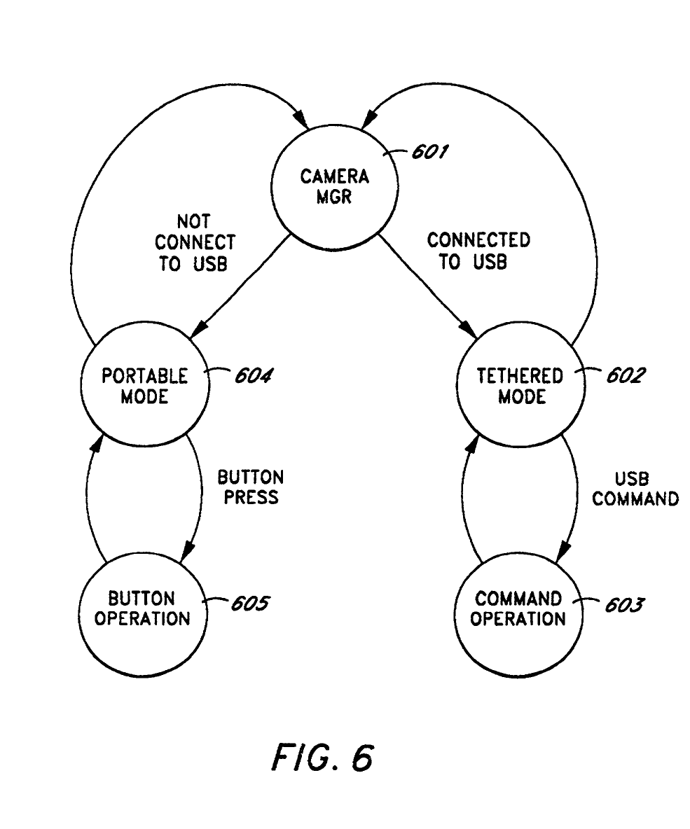

FIG. 6 illustrates an exemplary state machine of the present invention. In portable mode, the digital camera 104 functions as a still camera that is capable of recording images to a non-volatile memory. The images are saved by the digital camera 104 until they can be read by a host computer system 100 when the digital camera 104 becomes tethered to the host computer system 100 by the USB serial ports 107 and 108. The method by which a digital camera saves captured images is well known in the art. Operations are initiated by depressing buttons on the digital camera 104's external body.

When USB connectivity is detected by the present invention, the camera manager 501 transitions from state 601 to tethered mode in state 602. The tethered mode manager 504 polls the USB serial port 107 for incoming commands issued by the host computer system 100.

In one embodiment, the commands require the digital camera 104 to perform operations including but not limited to reading the stored images from a non-volatile memory, deleting or releasing the stored images from non-volatile memory, capturing a live picture from a sensor 302 and forwarding the captured image to the host computer system 100 via the USB serial ports 107 and 108 and begin streaming video. Streaming video refers to the continuous capture and transmission of images from a digital camera to the host computer system and is well known in the art. The command operations are processed in state 603.

While the commands are being processed in state 603, the camera manager 501 continues to poll the USB serial port 107 for live VBUS signal 210. While the VBUS signal 210 is being provided by the USB serial port 107, the state remains in the tethered mode 602 and the command operation state 603. If the VBUS signal 210 is discontinued, then camera manager 501 transitions to portable mode state 604 in which button presses are detected on the buttons of the exterior body of the digital camera 104. The button operations are processed in state 605.

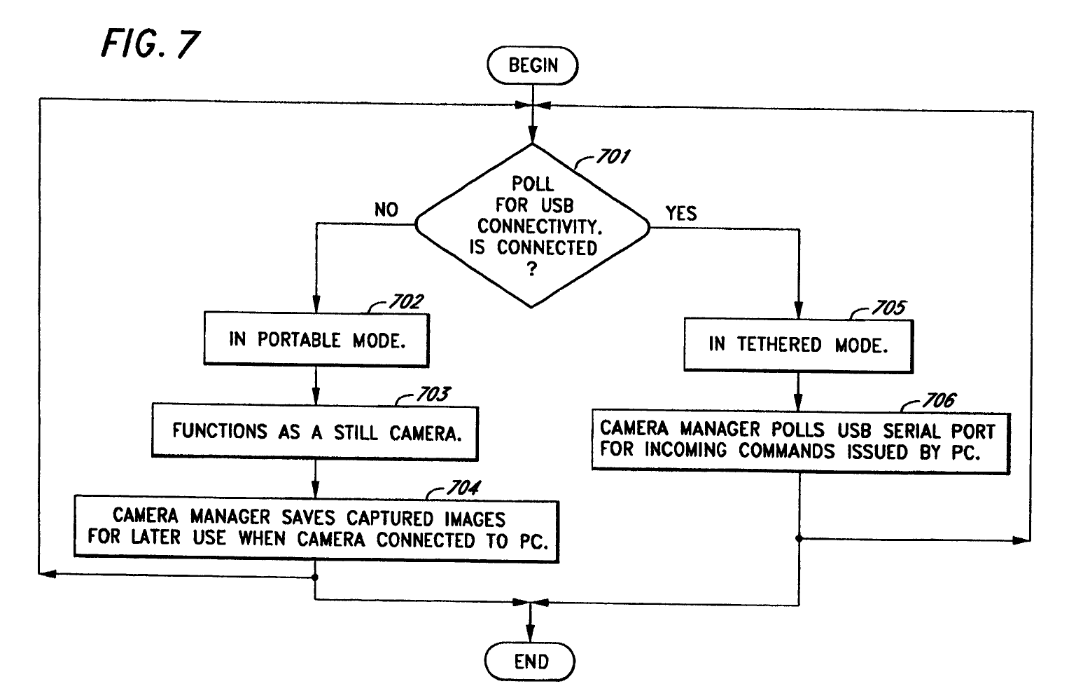

FIG. 7 is a flow diagram illustrating the general steps followed by the present invention. In step 701, VBUS signal checker 500 of the camera manager 501 periodically polls the software readable register 207 for VBUS connectivity. In step 702, while the VBUS signal 210 is turned off, the digital camera 104 is in portable mode. In step 703, in the portable mode, the digital camera 104 functions as a still camera capable of recording images to an non-volatile memory. In step 704, the camera manager 501 saves captured images until they can be read by the host computer system 100 in the tethered mode. The operations to be performed by the digital camera 104 in portable mode are initiated by depressing buttons on the digital camera 104 body.

In step 705, if a VBUS signal 210 is turned on, then the digital camera 104 is in tethered mode. In step 706, in the tethered mode, the camera manager 501 continues to poll the USB serial port 107 to detect USB connectivity while accepting operation commands from the host computer system 100 through the USB serial port 107. In this way, the digital camera 104 of the present invention supports automatic transition between tethered mode and portable mode for a digital camera without the need for user intervention.

What has been described is a method and apparatus to automatically control the behavior of a digital camera by detecting connectivity to a universal serial bus (USB) coupling to a host computer system. More specifically, the control of the dual mode operation to support both portable and tethered mode functionality is predicated by the present invention detecting USB serial port connectivity to a host computer system. The use of a VBUS signal to control the digital camera's behavior removes the need for having an extra user selectable switch to select a functional mode.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed:

1. A method for controlling behavior of a digital camera comprising:
detecting connectivity of the digital camera to a universal serial bus (USB); and
switching the digital camera to a predetermined mode of operation depending on the result of said detecting.

2. The method of claim 1 further comprising switching to tethered mode if the result of said detecting indicates that said digital camera is connected to said USB.

3. The method of claim 1 further comprising switching to portable mode if said detecting indicates that said digital camera is not connected to said USB.

4. The method of claim 1 wherein said detecting further comprises storing voltage bus (VBUS) signal input from a USB cable line in a software readable register.

5. The method of claim 4 further comprising determining whether a VBUS signal is asserted by reading a pre-determined location in said software readable register.

6. The method of claim 5 wherein said VBUS signal enables a VBUS bit to be asserted in said software readable register if said VBUS signal is asserted.

7. The method of claim 5 wherein said VBUS signal checker reads said pre-determined location for said VBUS bit.

8. An apparatus for controlling the behavior of a digital camera comprising:
a camera manager configured to control the behavior of the digital camera by detecting connectivity of said digital camera to a universal serial bus (USB); and
a software readable register coupled to said camera manager configured to hold a VBUS value indicative of connectivity of said digital camera to said USB.

9. The apparatus of claim 8 wherein said camera manager further comprises a VBUS signal checker configured to poll a pre-determined location in said software readable register to read said VBUS value indicative of connectivity of said digital camera to said USB.

10. The apparatus of claim 8 wherein said VBUS signal checker transitions to tethered mode if said VBUS value is a bit which is asserted in said software readable register.

11. The apparatus of claim 9 wherein said VBUS signal checker transitions to portable mode if said VBUS value is a bit which is unasserted.

12. The apparatus of claim 10 wherein said camera manager further comprises tethered mode manager configured to process incoming commands through said USB while said digital camera is in said tethered mode.

13. The apparatus of claim 11 wherein said camera manager further comprises portable mode manager configured to process button operations on said digital camera while said digital camera is in portable mode.

14. A system for controlling the behavior of a digital camera comprising:
a camera manager configured to control the behavior of the digital camera by detecting connectivity of said digital camera to a universal serial bus (USB); and
a software readable register coupled to said camera manager configured to hold a VBUS value indicative of connectivity of said digital camera to said USB; and
a microprocessor coupled to a storage element and configured to execute code for controlling the behavior of said digital camera.

15. The system of claim 14 wherein said camera manager further comprises a VBUS signal checker configured to poll a pre-determined location in said software readable register to read said VBUS value indicative of connectivity of said digital camera to said USB.

16. The system of claim 14 wherein said VBUS signal checker transitions to tethered mode if said VBUS value is asserted in said software readable register.

17. The system of claim 15 wherein said VBUS signal checker transitions to portable mode if said VBUS value is unasserted.

18. The system of claim 16 wherein said camera manager further comprises tethered mode manager configured to process incoming commands through said USB while said digital camera is in said tethered mode.

19. The system of claim 17 wherein said camera manager further comprises portable mode manager configured to process button operations on said digital camera while said digital camera is in portable mode.

20. A system for controlling the behavior of a digital camera, including code configured for storage on a computer-readable apparatus and executable by a computer, the code including a plurality of modules each cofigured to carry out at least one function to be executed by the computer, the system comprising:
a camera manager module configured automatically switch the mode of the digital camera when a universal serial bus (USB) connectivity is detected; and
a bus signal checker module configured to detect said USB connectivity.
